(19) United States
(12) Patent Application Publication
(10) Pub. No.: US 2002/0050700 A1
(43) Pub. Date: May 2, 2002

(54) Baby stroller with retracable and foldable frame

(76) Inventors: Richard M. Stohr, Yakima, WA (US); Rene Garza, Toppenish, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/751,418

(22) Filed: Dec. 29, 2000

Related U.S. Application Data
(63) Continuation-in-part of application No. 09/699,045, filed on Oct. 27, 2000.

(51) Int. Cl. B62B 7/06

(52) U.S. Cl. 280/650; 280/47.38

(57) ABSTRACT

A baby stroller comprising a foldable and retractable frame with a bottom frame member, a top frame member, and an upright frame member. Each frame member has left and right spaced apart frame tubes in parallel relationship to one another. The upright frame member is pivotally connected to both the top and bottom frame members. In one embodiment, extended pivot links are pivotally connected to both the top and bottom frame members, and the front wheel is removably attached to the extended pivot links when the stroller is in an operating position. At least the top and bottom frame tubes each have retractable tube sections, wherein at least two tube sections are configured such that one is retractable within the other to move between an extended position and a retracted position. Rear and front wheels are removable.

### CROSS-REFERENCE TO RELATED APPLICATION

This application is a continuation-in-part of U.S. patent application Ser. No. 09/699,045, filed Oct. 27, 2000, now pending, which is incorporated herein by reference in its entirety.

### TECHNICAL FIELD

The present invention relates to baby strollers, and more particularly to all-terrain baby strollers that can be collapsed and their wheels removed.

### BACKGROUND OF INVENTION

Traditionally, baby strollers have been used to push an infant slowly on a relatively hard, smooth floor or sidewalk. As a result, the strollers were made small and light. These strollers work well enough at slow speed, but are extremely unwieldy and even dangerous on rough surfaces or at higher speeds.

As parents have become more health conscious in recent times, jogging and fast walking has become a popular pastime. Because baby strollers were not designed to be operated at high speed or on rough terrain, parents could jog or fast walk only when another person was available to baby-sit. As any parent knows, it is not always easy to find babysitters, so the ability of the parent to stay in shape by jogging or fast walking was severely limited.

Even for non-jogging parents, the need for an improved baby stroller has been apparent. The small, plastic wheels customarily used for the baby strollers are almost useless when it is desired to walk with an infant in a grassy park or on a rough road or sidewalk. Parents end up not walking with the infant at all or only walking in limited areas.

Recently, all-terrain baby strollers have been designed to overcome these problems. These strollers typically employ much larger wheels, often large bicycle tires. The stroller frame and frame connections are constructed to be stronger and larger to handle the heavy duty use they may receive. It is now quite common to see a parent pushing an infant while jogging, fast walking or even just slow walking in grassy, bumpy areas or over other rough terrain.

These new strollers have their drawbacks. The increased size and durable construction make the stroller much larger and heavier than in the past, and as a result much more difficult to transport, especially as car sizes have decreased. Not everyone has access to large vehicles or to tools to take the stroller apart for transport. Even if tools were available, it is not practical or convenient to take the time needed to dismantle the stroller each time it is to be transported. Further, the larger size all-terrain strollers makes their storage difficult.

Foldable frames for all-terrain strollers help in the problem of difficult storage. However, even then, the large frame pieces are not reduced in size and remain long and bulky so that storage is nevertheless, a problem. The present invention solves these problems by providing a quick and easy way to further reduce the storage size of a stroller.

### SUMMARY OF INVENTION

The present invention resides in a baby stroller with a retractable and folding frame. The frame of the baby stroller has a top left member and a top right member, a bottom left member and a bottom right member, and an upright left member and an upright right member. The rearward end portions of the top frame members are pivotally connected to the rearward end portions of the upright frame members and the lower end portions of the upright frame members are pivotally connected to the rearward end portions of the bottom frame members. In one embodiment, the forward end portions of the top frame members are releasably connected to the forward end portions of the bottom frame members. There is at least one rear wheel removably and rotatably mounted to the frame and at least one front wheel removably and rotatably mounted to the frame.

When the stroller is in an operating position, the top frame members slope downward from the rearward end portions to the forward end portions, the bottom frame members are horizontally disposed, and the upright frame members are substantially vertically disposed.

In one embodiment, there is at least one extension-retraction connection, or retractable section, on at least each of the left and right bottom frame members and each of the left and right top frame members. The extension-retraction connections divide each frame member into two sections. The extension-retraction connection is configured to permit the two sections of the corresponding frame member to move along the longitudinal axis of the frame member in relation to one another, between an extended position and a retracted position. The two sections retain substantially the same alignment in relation to one another from the start of the movement through to the end of the movement. The length of the frame member is greater in the extended position than in the retracted position.

In one embodiment, when the releasable connections between the front end portions of the top frame members and the front end portions of the bottom frame members are released, the vertical frame members, the bottom frame members, and the top frame members are all able to be folded from the operating position of the stroller to a collapsed position, wherein all of the frame members are disposed in substantial parallel alignment. With all of the extension-retraction connections proper adjusted, the two sections of each frame member can be placed in the retracted position and the wheels of the baby stroller removed. This results in the stroller, when in the collapsed position, having a substantially smaller total size for the stroller than when in the operating position. This is significantly aided by the presence of the extension-retraction connections on the frame members. As such, storage is made significantly easier.

In another embodiment, the connections between the forward end portions of the top and bottom frame members comprise pivot links. The pivot links are pivotally connected to both the top frame members and the bottom frame members so that the frame members are able to move in relation to one another through a limited range of motion. In this manner, the frame members can be moved from the operating position described above with respect to the first alternative embodiment, to a collapsed position wherein all the frame members are positioned in substantial parallel alignment, without having to completely disconnect the forward end portions of the top frame members from the forward end portions of the bottom frame members. The pivot links can be secured in an operating position.

In yet another embodiment, there are also linking members like the pivot links, with the links being further extended. These extended pivot links also allow the stroller to be collapsed from the operating position described above to a collapsed position, without releasing the forward ends of the top and bottom frame members. Again, in this embodiment, the collapsed position comprises the top, bottom, and upright frame members being in substantial parallel alignment. The extended pivot links are also pivotally connected to both the forwards ends of the top frame members and the bottom frame members, such that the top frame member, and bottom frame member are able to pivot in relation to the extended pivot links, from the operating position to the collapsed position. There is at least one front wheel of the stroller that is rotatably and removably attached to the forward end portion of the extended pivot links when the stroller is in the operating position. When the stroller is collapsed, the extended pivot links are pivoted so that their forward ends are folded inward or rearward to a position behind the forward end of the top frame member. This helps further reduce the size of the stroller in the collapsed position.

### BRIEF DESCRIPTION OF DRAWINGS

FIG. 1 is an isometric view of a first baby stroller embodiment of the present invention having a releasable connection between the top and bottom frame tubes, but without a seat being shown, with the frame in the operating position and none of the frame tubes in the retracted position.

FIG. 2 is an enlarged, fragmentary side view showing an extension-retraction connection used with the bottom and upright frame tubes.

FIG. 3 is an enlarged, fragmentary side view showing two extension-retraction connections used with the top frame tubes.

FIG. 4 is an isometric view of the baby stroller of FIG. 1 with a seat being shown and with the frame in the operating position and none of the frame tubes in the retracted position

FIG. 5A is a side elevational view of the baby stroller of FIG. 1 in the operating position.

FIG. 5B is a fragmentary, side elevational view of the front end portion of a baby stroller similar to the stroller of FIG. 1 showing an alternative embodiment in which the bottom frame tubes have an additional extension-retraction connection.

FIG. 6 is a side elevational view of the baby stroller of FIG. 1 with the releasable connection between the top and bottom frame tubes shown released.

FIG. 7 is a side elevational view of the baby stroller of FIG. 1 showing continuation of the collapsing sequence begun in FIG. 6, illustrating the rotational direction of the top frame tubes during collapsing.

FIG. 8 is a side elevational view of the baby stroller of FIG. 1 showing continuation of the collapsing sequence from FIG. 7, illustrating the rotational direction of the bottom frame tubes during collapsing and a handle portion of the top frame tubes retracts.

FIG. 9 is a side elevational view of the baby stroller of FIG. 1 showing continuation of the collapsing sequence from FIG. 8, illustrating the further rotational direction of the bottom frame tubes during collapsing and the retraction of the bottom frame tubes.

FIG. 10 is a side elevational view of the baby stroller of FIG. 1 showing the final collapsed position.

FIG. 11A is an isometric view of a second baby stroller embodiment of the present invention having pivot links connecting the top frame tubes to the bottom frame tube, but without a seat being shown, with the frame in the operating position and none of the frame tubes in the retracted position.

FIG. 11B is a fragmentary isometric view of the front end of the baby stroller of FIG. 11 with the footrest in broken line to show a cross plate between the pivot links and a latch used to releasably secure the foot plate of the stroller to the cross plate.

FIG. 12 is an isometric view of the baby stroller of FIG. 11 with a seat being shown.

FIG. 13 is a side elevational view of the baby stroller of FIG. 11 in the operating position.

FIG. 14 is a side elevational view of the baby stroller of FIG. 11 with a latch shown released and the pivot links being positioned to begin the collapsing sequence for the stroller.

FIG. 15 is a side elevational view of the baby stroller of FIG. 11 showing continuation of the collapsing sequence begun in FIG. 14, illustrating the pivot links folded forward and the handle portion and lower portion of the top frame tubes and the upright frame tubes partially retracted.

FIG. 16 is a side elevational view of the baby stroller of FIG. 11 showing continuation of the collapsing sequence from FIG. 15, illustrating the upright frame tubes folding forward and the lower portion of the top frame tubes and the upright frame tubes being further retracted.

FIG. 17 is a side elevational view of the baby stroller of FIGS. 11 showing the final collapsed position in the collapsing sequence from FIG. 16.

FIG. 18A is an isometric view of another baby stroller embodiment of the present invention having extended pivot links with fork tips, connecting the top frame tubes to the bottom frame tubes, but without a seat being shown, with the frame in the operating position and the frame tubes extended.

FIG. 18B is an enlarged, fragmentary isometric view of the front end of the baby stroller of FIG. 18A with a foot rest only partially shown to reveal the rotatable sleeves of the extended pivot links.

FIG. 19 is an isometric view of the baby stroller of FIG. 18A with a seat being shown.

FIG. 20A is a side elevational view of the baby stroller of FIG. 18A in the operating position.

FIG. 20B is a fragmentary side elevational view of one of the upright frame tubes showing an alternative embodiment to FIG. 20A wherein the upright frame tubes each have at least one retractable tube section.

FIG. 20C is a fragmentary side elevational view of one of the top frame tubes showing an alternative embodiment to FIG. 20A wherein the top frame tubes each have at least two retractable tube sections.

FIG. 21 is a side elevational view of the baby stroller of FIG. 18A in the operating position without the wheels being shown, and with the latch released in preparation to begin the collapsing sequence for the stroller.

FIG. 22 is a side elevational view of the baby stroller of FIG. 18A showing continuation of the collapsing sequence begun in FIG. 21, illustrating the lower tube sections of the top framed tubes in retracted positions, the second tube sections of the bottom frame tubes in partially retracted positions, and the extended pivot links partially pivoted with respect to the top frame tubes and the bottom frame tubes such that the rotatable sleeves of the extended pivot links are positioned forward of their operating position.

FIG. 23 is a side elevational view of the baby stroller of FIG. 18A showing continuation of the collapsing sequence begun in FIG. 21, illustrating the forward end portions of the extended pivot links folded toward the rear of the stroller and the second tube sections of the bottom frame tubes further retracted.

FIG. 24 is a side elevational view of the baby stroller of FIG. 18A showing a fully collapsed position of the stroller from the collapsing sequence begun in FIG. 21, illustrating the extended pivot links being further folded forward, all of the frame tubes being in substantial parallel alignment, and all of the retractable tube sections in retracted positions.

FIG. 25 is a side elevational view of the baby stroller of FIG. 18A showing the collapsed position of FIG. 24 with a front wheel attached to the fork tips such that the wheel is disposed between the left and right frame tube, of the collapsed top frame tubes, upright frame tubes, and bottom frame tubes.

### DETAILED DESCRIPTION OF THE INVENTION

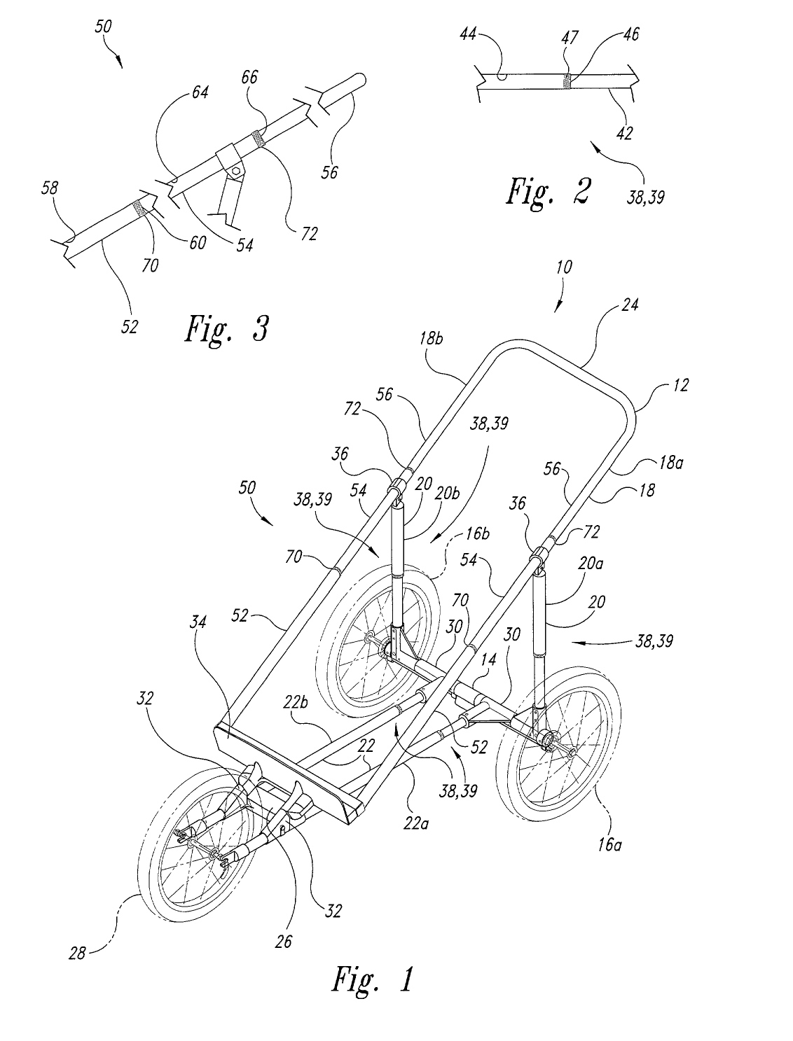

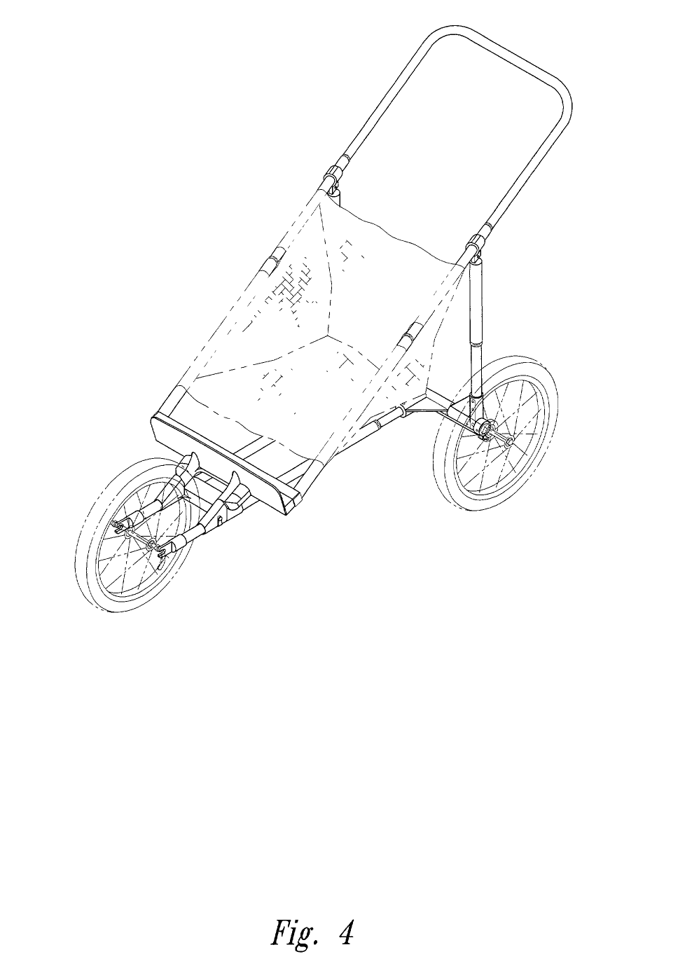

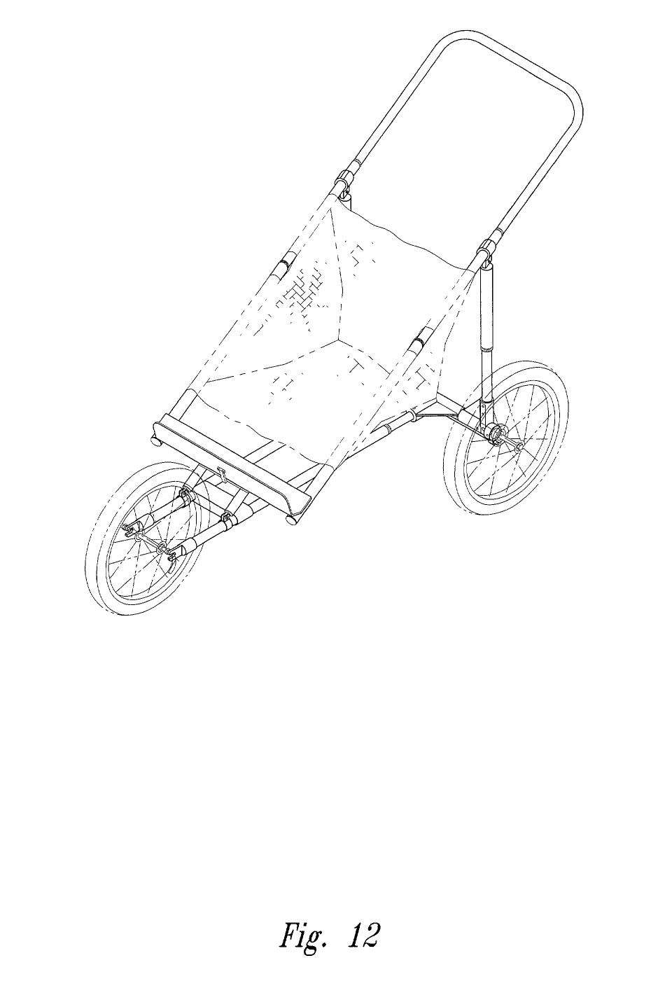

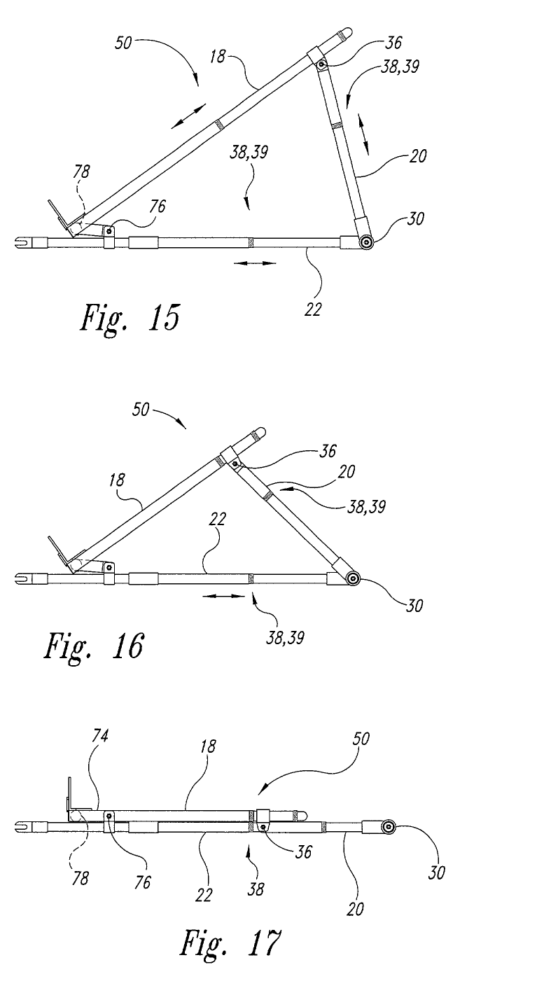

The present invention is a baby stroller with a retracting frame. Specific details of certain embodiments of the invention are set forth in the following description and in FIGS. 1-25 to provide a thorough understanding of such embodiments. One skilled in the art, however, will understand that the present invention may have additional embodiments, or that the invention may be practiced without several of the details described in the following description.

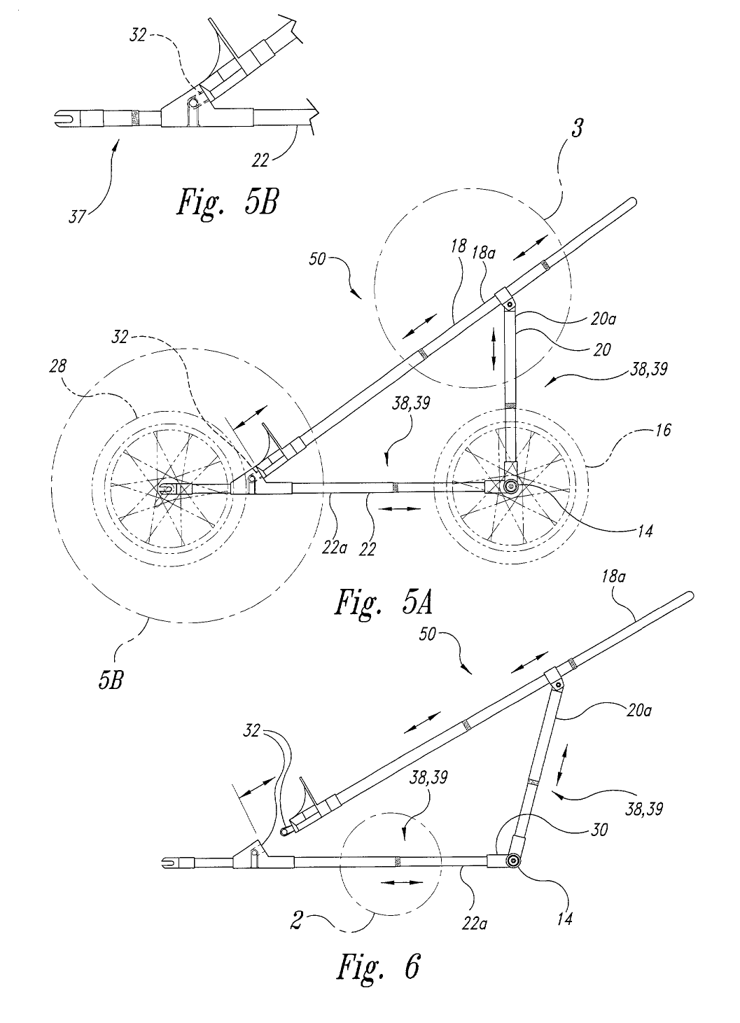

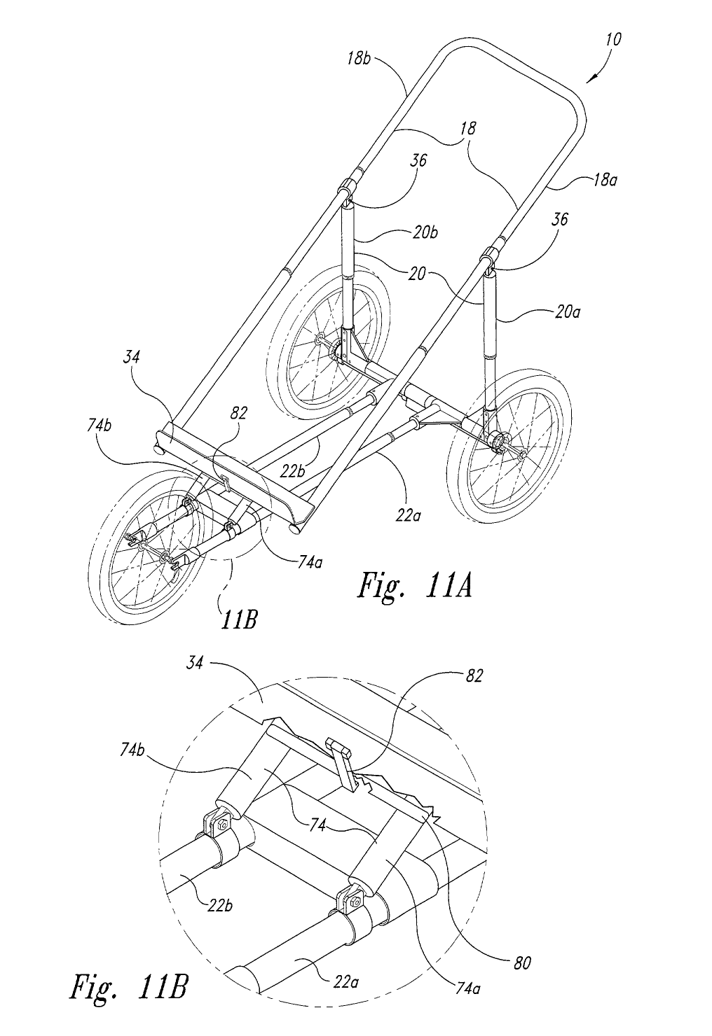

As illustrated in the drawings, and as best seen in FIG. 1, a stroller 10 with a retracting and folding frame 12 is described herein. The frame of the baby stroller has a top frame member 18, a bottom frame member 22, and an upright frame member 20. Each of the frame members comprises a left side frame tube and a right side frame tube. The frame tubes of each member are in substantial parallel alignment and spaced apart in relation to one another. Each embodiment of the stroller is described for two positions, an operating position, as illustrated in FIGS. 5A, 13, and 20A and a collapsed position, as illustrated in FIGS. 10, 17, and 24.

The first embodiment, also shown in the operating position in FIG. 1, comprises top left and right frame tubes 18a and 18b of the top frame member 18 sloping downwardly with the forward ends of the frame tubes being lower than the rearward ends. The rearward ends are joined by a handle portion 24 for pushing the stroller. The handle portion also maintains the left and right top frame tubes 18a and 18b in substantial parallel alignment and spaced apart relation to one another. There is a rectangular flat foot plate 34 that is laid lengthwise and transversely across the forward end portions of the left and right top frame tubes. The foot plate 34 is disposed such that the plane of the surface of the foot plate is transverse to the top frame tubes 18a and 18b, and an inside edge of the foot plate is set against the top frame tubes. The left side of the foot plate 34 is fixedly attached to the forward end portion of the left top frame tube and the right side of the foot plate 34 is fixedly attached to the forward end portion of the right top frame tube. The foot plate 34 is, in turn, releasably attached to a cross piece 26, by left and right releasable connections 32 when the stroller is in the operating position. Each releasable connection comprises an insertion piece, fixedly attached to the foot plate, and a receiver, fixedly attached to the bottom frame tubes. The two pieces lockably engage when the insertion piece is mated with the receiver, and are configured to the release cable. The cross piece 26 is attached to and holds left and right bottom frame tubes 22a and 22b of the bottom frame member 22 in parallel alignment, spaced apart relation to one another. The bottom frame tubes 22a and 22b are disposed horizontally while the stroller is the operating position, as shown in FIG. 1.

There is a rear cylindrical axle 14 with a left end and a right end, and a longitudinal axis extending between the ends. The longitudinal axis of the axle 14 extends laterally and transversely with respect to the bottom left and right frame tubes 22a and 22b, across the rearward ends of the bottom left and right frame tubes. When the stroller is in the operation position, a left rear wheel 16a is removably and rotatably mounted on the left end of the rear axle 14 and a right rear wheel 16b is removably and rotatably mounted on the right end of the rear axle. A front wheel 28 is removably and rotatably mounted to and between the forward ends of the bottom frame tubes 22a and 22b proximate and forward of the cross piece 26.

The rearward ends of the bottom left and right frame tubes 22a and 22b are fixedly connected to left and right couplers 30 that are, in turn, pivotally coupled to the rear axle 14. As such, the bottom left and right frame tubes 22a and 22b are able to pivot about the longitudinal axis of the rear axle 14, together in parallel, when the forward ends of the bottom frame tubes 22a and 22b are freed from the releasable connections 32 of the cross piece 26.

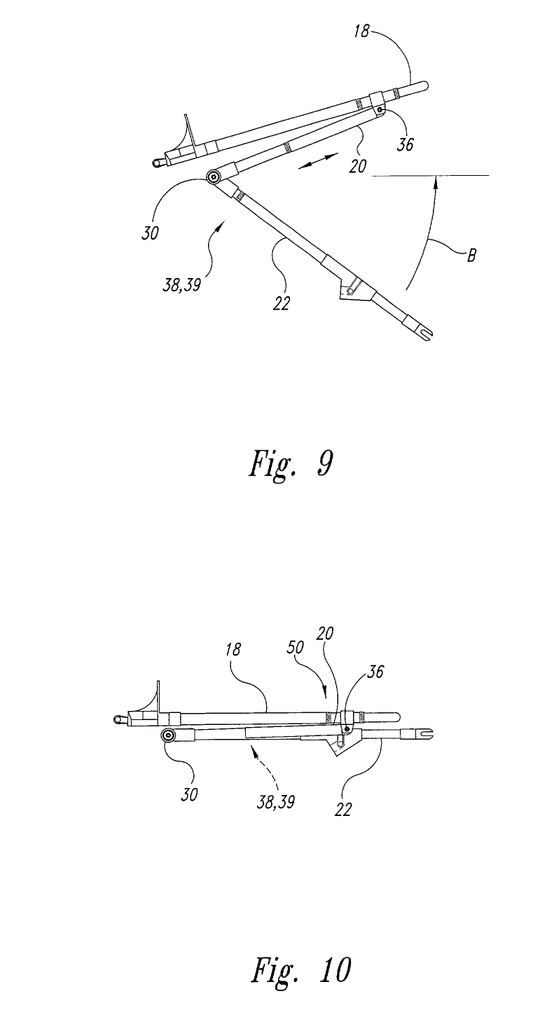

The pivoting couplers 30, connecting the left and right bottom frame tubes 22a and 22b and the rear axle 14, are configured to allow the bottom frame tubes to pivot from the operating position shown in FIG. 5A, downward as indicated by the arrow “A” in FIG. 8, and to pivot as indicated by arrow “B” in FIG. 9 into the position shown in FIG. 9 and then into the collapsed position shown in FIG. 10, where the bottom frame tubes 22a and 22b are in substantial parallel alignment with and adjacent to the upright frame tubes 20a and 20b. The collapsed position is only attainable when the releasable connections 32 are released. FIGS. 5A and 6-10 are frame by frame depictions of the stroller 10 as it is collapsed. The collapsed position of FIG. 10 involves rotating the bottom frame tubes 22a and 22b about a 270 degrees away from the operating position of FIG. 5 as measured by the angle, in a vertical plane, between the bottom frame tubes and the upright frame tubes 20a and 20b when in the operating position.

The upright frame tubes 20a and 20b are also in substantial parallel alignment and spaced apart in relation to one another, and are held in such position by the upper ends of the left and right upright frame tubes being pivotally connected to mid-portions of the top frame tubes 18a and 18b, respectively, and the lower ends of the left and right upright frame tubes being connected to the rear axle 14. When the stroller is in the operating position, as shown in FIG. 1, the upright frame tubes 20a and 20b are disposed in a substantially vertical position. The rear axle 14 is disposed horizontally and transversely with respect to the upright frame tubes.

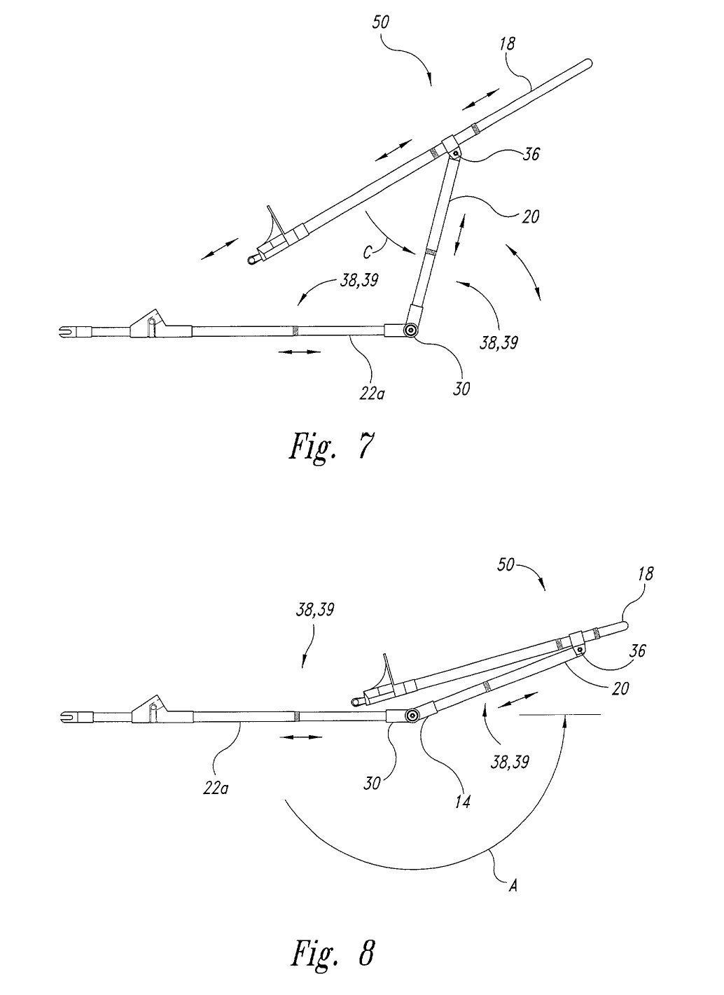

The upper ends of the left and right upright frame tubes 20a and 20b are each pivotally connected to the mid-portions of the left and right top frame tubes 18a and 18b by left and right pivoting connections 36. The left and right pivoting connections 36 are configured to allow the top frame tubes 18a and 18b to pivot about an axis extending laterally and transversely across the upright frame tubes, centered at about the upper ends of the upright frame tubes where the pivoting connections 36 are located. The pivoting connections 36 are further configured to allow the top frame tubes to pivot from the operating position shown in FIG. 5A, downward as indicated by the arrow “C” in FIG. 7, and to pivot into the position shown in FIG. 9 and then into the collapsed position shown in FIG. 10, where the top frame tubes 18a and 18b are in substantial parallel alignment with and adjacent to the upright frame tubes 20a and 20b. The collapsed position is only attainable when the releasable connections 32 are released. The collapsed position of FIG. 10 involves rotating the top frame tubes less than a 90 degrees away from the operating position of FIG. 5, as measured by the angle, in a vertical plane, between the top frame tubes and the upright frame tubes. As will now be described, in addition to the folding arrangement of the top frame, bottom frame and upright frame members 18, 22, 20 just described to place the stroller 10 in the collapsed position, these frame members can also be shortened in length using a variety of telescoping extension-retraction connections.

As best seen in FIGS. 1 and 2, the left and right bottom frame tubes 22a and 22b and the left and right upright frame tubes 20a and 20b each have a telescoping extension-retraction connection 38, 39 allowing selective extension and retraction of the corresponding frame tube. Each extension-retraction connection of a frame tube includes a first longitudinal tube section 40 and a second longitudinal tube section 42, as numbered in FIG. 2. The first section 40 has an interior cylindrical chamber 44 with an opening 46 facing the second section 42. The second section 42 has an exterior cylindrical mating portion 48 configured to slidably fit within the interior cylindrical chamber 44 of the first section 40. The mating portion 48 and the chamber 44 are configured such that the mating portion is axially movable within the cylindrical interior chamber, in coaxial alignment with the chamber, between an extended position and a retracted position. The length of the entire frame member is greater in the extended position than in the retracted position. The extension-retraction connection 38, 39 also includes a releasable lock 47 that can be used to selectively lock the connection in either the retracted or extended position.

As best seen in FIGS. 1 and 3, the left and right top frame tubes 18a and 18b each have a telescoping extension-retraction connection 50 which allows selective extension and retraction of the corresponding frame tube at two locations. Each extension-retraction connection of the top frame tube includes a lower longitudinal tube section 52, a middle longitudinal tube section 54, and an upper longitudinal tube section 56. As numbered in FIG. 3, the lower section 52 has an interior cylindrical chamber 58 with an opening 60 facing the middle section 54. The middle section 54 has an exterior cylindrical mating portion 62 configured to slidably fit within the interior cylindrical chamber 58 of the lower section 52. The middle section 54 has an interior cylindrical chamber 64 with an opening 66 facing the upper section 56. The upper section 56 has an exterior cylindrical mating portion 68 configured to slidably fit within the interior cylindrical chamber 64 of the middle section 54. The corresponding mating portions 62, 68 and chambers 58, 64 of each extension-retraction connection 50 is configured such that the mating portion is axially movable within the corresponding cylindrical interior chamber, in coaxial alignment with the chamber, between an extended position and a retracted position. The length of the entire top frame member is greater in the extended position than in the retracted position. The extension-retraction connection 50 also includes releasable locks 70 and 72, with lock 70 configured to selectively lock the lower and middle sections 52, 54 in either the retracted or extended position, and with lock 72 configured to selectively to lock the middle and upper sections 54, 56 in either the retracted or extended position.

In another embodiment, seen in FIG. 5B, the left and right bottom frame tubes 22a and 22b, at a location forward of the connections 32, each also have an additional telescoping extension-retraction connection 37 which allows selective extension and retraction thereof configured much as the extension-retraction connections 38, 39 shown in FIG. 2.

When the stroller is in an operating position of FIG. 5A, the releasable connections 32 of the cross piece 26 are secured to hold the forward ends of the top frame tubes 18a and 18b securely connected to the forward ends of the bottom frame tubes 22a and 22b. Also, each of the extension-retraction connections 38, 39 and 50 are placed in the extended position and locked in place by the releasable locks 47, 70, 72. The top frame tubes 18a and 18b are downwardly sloping and the upright frame tubes 20a and 20b are substantially vertical. When the stroller is to be stored in a collapsed position, the releasable connections 32 of the cross piece 26 are released to free the forward ends of the top frame tubes 18a and 18b from the forward ends of the bottom frame tubes 22a and 22b as shown in FIG. 6. Each extension-retraction connection of the left and right frame tubes of the top frame member 18, the bottom frame member 22, and the upright frame member 20, is then placed and locked in the retracted position as part of the process of folding the stroller 10 into the collapsed position shown in FIG. 10. Also, as part of the process, the removable front wheel 28, and the removable left and right rear wheels 16a and 16b, are removed, if desired. The resulting, fully collapsed stroller occupies significantly less space than the stroller in the operating position, with the improved compactness made possible by the extension-retraction connections.

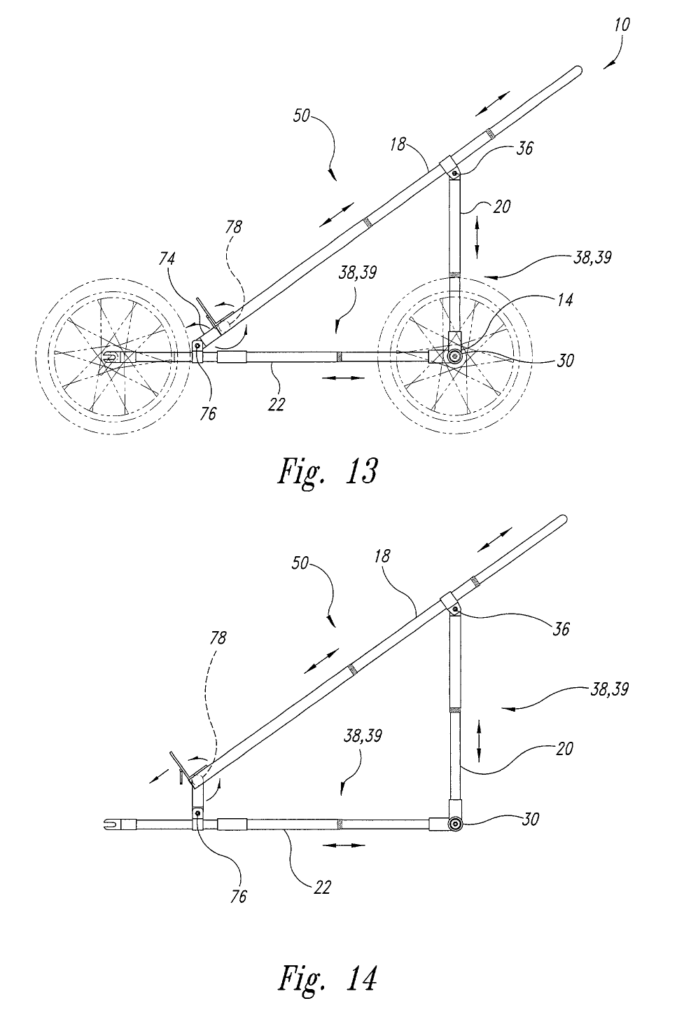

In a second embodiment of the stroller 10 shown in FIGS. 11-17, the forward ends of the top frame tubes 18a and 18b and the forward ends of the bottom frame tubes 22a and 22b cannot be fully disconnected from each other, but are instead, joined by pivot links 74. As best seen in FIGS. 11A and 11B, there is a left cylindrical pivot link 74a that pivotally connects the forward end of the left bottom frame tube 22a with the forward end of the left top frame tube 18a, and there is a right cylindrical pivot link 74b that pivotally connects the forward end of the right bottom frame tube 22b with the forward end of the right top frame tube 18b. As seen in FIG. 13, each pivot link has a bottom pivot joint 76 and a top pivot joint 78 at its bottom and top ends, respectively, which form the pivotal connections between the pivot links and the corresponding bottom frame tube and top frame tube.

The bottom pivot joints 76 allow the pivot links 74a and 74b to pivot around an axis extending laterally and transversely across the left and right bottom frame tubes 22a and 22b, centered near the forward ends of the bottom frame tubes. The top pivot joints 78 allow the pivot links to pivot around an axis extending laterally and transversely across the left and right top frame tubes 18a and 18b, centered near the forward ends of the top frame tubes. The bottom and top pivot joints 76 and 78 are further configured such that as the stroller 10 is folded the pivot links 74a and 74b are able to pivot from an operating position, as shown in FIG. 13, in which the pivot links are aligned so that the top pivot joints 78 are positioned above and rearward of the bottom pivot joints 76, with the pivot links extending downwardly like the top frame tubes 18a and 18b, to the collapsed position, as shown in FIG. 17. In the collapsed position, the pivot links 74a and 74b are in substantial parallel alignment with the top frame tubes 18a and 18b and the bottom frame tubes 22a and 22b, with the top pivot joints 78 positioned forward of the bottom pivot joints 76.

In this second embodiment, when the stroller 10 is in the collapsed position, as shown in FIG. 17, the upright frame tubes 20a and 20b are in substantial parallel alignment with the top frame tubes 18a and 18b as well as the bottom frame tubes 22a and 22b, and the bottom frame tubes are positioned between the upright frame tubes. Further, the extension-retraction connections 50 on the top frame tubes 18a and 18b and the extension-retraction corrections 38, 39 on the upright frame tubes 20a and 20b are placed and locked in the retracted position. In some embodiments, the stroller is also configured so that the bottom frame tubes 22a and 22b can also be placed, and preferably locked, in the retracted position. The sequence of folding the stroller is shown in FIGS. 13-17. The pivot connections 36 between the upright frame member 20 and top frame member 18 as well as the couplers 30 between the bottom frame member 22 and the rear axle 14, are configured to allow the upright frame member 20 to fold from the operating position, shown in FIG. 13, to the collapsed position, shown in FIG. 17, by folding forward and downward with respect to the bottom frame member 22. As the upright frame member is connected to the rear axle, the rear axle rotates with respect to the bottom frame member 22 as this occurs. The extension-retraction connections 50, 38, 39 are configured to allow retraction of the top frame tubes 18a and 18b and the upright frame tubes 20a and 20b as necessary until the collapsed position is reached.

As shown in FIG. 11B, there is flat rectangular catch bar 80 fixedly connected to the left and right cylindrical pivot links 74a and 74b. The catch bar 80 lays flat against the pivot links near the top pivot joints 78 thereof and extends lengthwise laterally and transversely across the pivot links. A lower edge of the catch bar 80 is positioned at a lower edge of the foot plate 34 when the stroller is in the operating position. A manually operable latch 82 is fixedly attached to and extends downward from the bottom surface of the foot plate to lockably engage the catch bar when the stroller is in the operating position. The latch 82 secures the foot plate 34 to the catch bar 80 when the stroller is in the operating position, and hence the cylindrical pivot links 74 are prevented from pivoting out of the operating positions and thereby prevent the stroller from folding to the collapsed position until the latch is manually released.

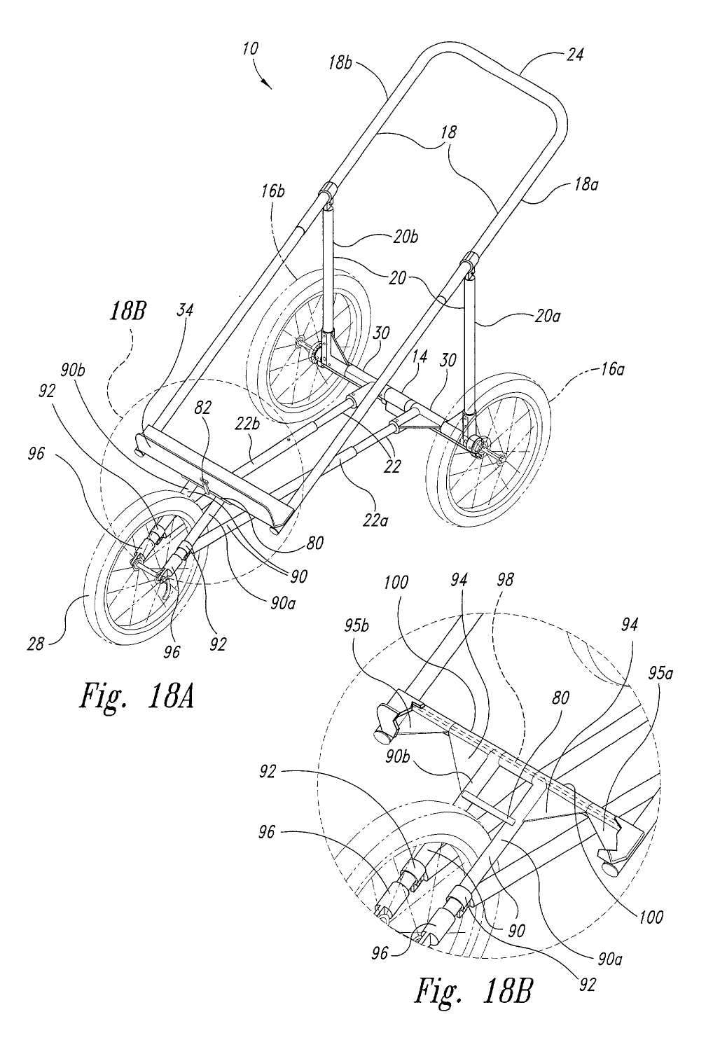

In a third embodiment of the stroller 10 illustrated in FIGS. 18A through 25, there are linking members between the top and bottom frame tubes, much like the pivot links 74, previously described. These linking members are extended to form extended cylindrical pivot links 90, as best seen in FIG. 18A. The front wheel of the stroller is connected to and between forward end portions of the extended pivot links. The extended pivot links are configured so that the forward end portions thereof fold downward and toward the rear of the stroller as it is being collapsed. This aids in further reducing the size of the stroller in the collapsed position by allowing the front wheel mounting portion of the stroller to fold.

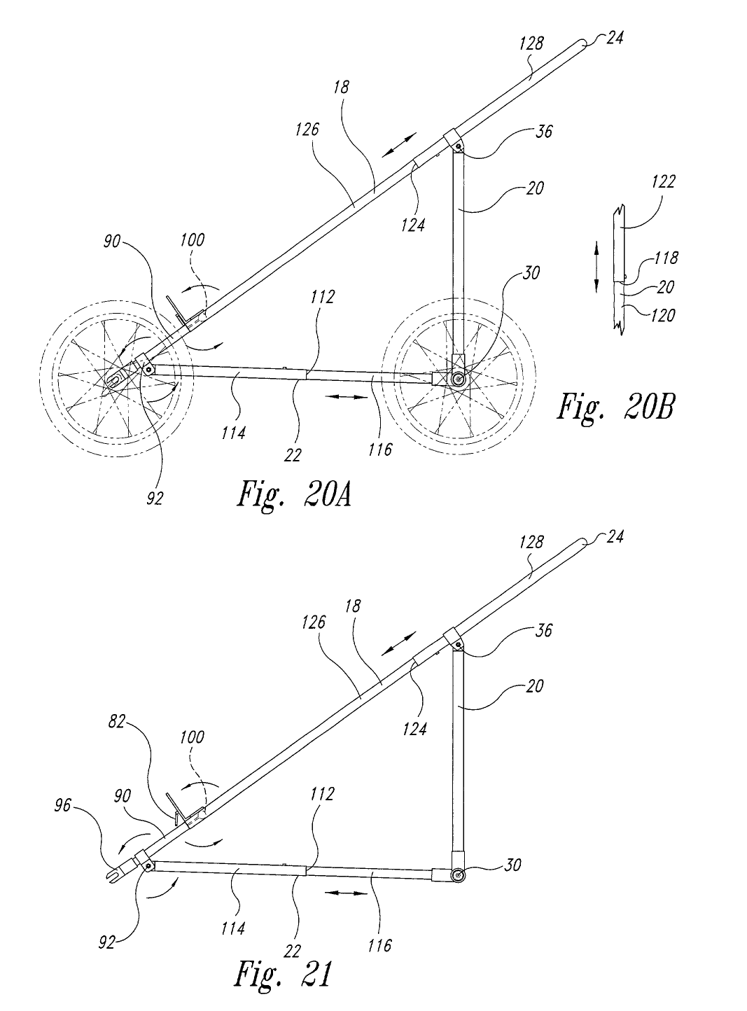

The extended pivot links 90 include left and right extended pivot tubes 90a and 90b, as best seen in FIGS. 18A and 18B, each having a forward end and a rearward end, as defined by the position of the ends relative to one another when the stroller is in the operating position, shown in FIG. 18A and 20A. Each extended pivot link 90 has a pivot joint 92 proximate its forward end portion and a rotatable sleeve 100 at its rearward end, as shown in FIGS. 18A and 18B. The left and right pivot joints 92 allow the corresponding left and right extended pivot tubes 90a and 90b to pivot around an axis extending laterally and transversely across the left and right bottom frame tubes 22a and 22b, near the forward ends of the bottom frame tubes. The left and right rotatable sleeves 100 allow the corresponding left and right extended pivot tubes to pivot around an axis extending laterally and transversely across the left and right top frame tubes 18a and 18b, centered near the forward ends of the top frame tubes.

The rotatable sleeves 100, as best seen in FIG. 18B, are cylindrical sleeves that are fixedly attached, transversely, to the rearward ends of the extended pivot tubes 90a and 90b. An axle 98 extends between the forward ends of the top frame tubes. The left and right rotatable sleeves 100 are mounted on the axle 98 so that the axle is coaxial within the sleeves and the sleeves are free to rotate about the axle. Left and right triangular gussets 94 are positioned between the rotatable sleeves and the extended pivot tubes to provide support between the two parts. In some embodiments, the connection between the rearward ends of the extended pivot tubes and the top frame tube members may comprise pivot joints similar to the pivot joints 92 that connect the forward end portions of the extended pivot tubes to the bottom frame tubes. Also, in some embodiments, the rearward ends of the extended pivot tubes may be fitted with a cylindrical endcap that is fixedly attached at a right angle to the rotatable sleeve. The endcap, the triangular gusset, and the rotatable sleeve, may be one piece.

The forward end portions of the extended pivot tubes 90a and 90b extend forward beyond the pivot joints 92 when in the operating position. A fork tip 96 is attached to the forward end of each of the left and right extended pivot tubes. During operation of the stroller 10, the front wheel 28 is disposed between the left and right fork tips 96, and is rotatably and removably attached to the fork tips, as best seen in FIG. 18A. It is further noted, that in the currently describe embodiment, when the stroller is in the operating position, the extended pivot tubes 90a and 90b are secured in position such that the rotatable sleeves 100 are positioned above and rearward of the bottom pivot joints 92, with the extended pivot tubes being disposed in a downwardly sloping position like the top frame tubes 18a and 18b with substantially the same slope. In addition, the extended pivot tubes are aligned so that they are substantially parallel to the top frame tubes but extend forward beyond the forward ends of the top frame tubes, as well as forward and below the forward ends of the bottom frame tubes 22a and 22b. The extended pivot tubes are secured in this position during operation of the stroller by the manually operable latch 82 and the rectangular catch bar 80 in a way similar to that previously described for the stroller embodiment illustrated in FIGS. 11A through 17. In the embodiment of FIG. 18B, the catch bar 80 is rectangular and lays lengthwise and transversely across the extended pivot tubes. Also, the catch bar 80 of this embodiment is positioned near the rearward ends of the extended pivot tubes. The latch 82 can be selectively positioned so that it lockably engages the catch bar and secures the extended pivot tubes in the operating position. When it is desired to collapse the stroller for storage, the latch can be released to allow the extended pivot tubes to pivot about the pivot joints 92 and the rotatable sleeves 100.

The currently described embodiment illustrated in FIGS. 18A through 25 includes extension retraction connections, or retractable or telescoping tube sections, on the top frame tubes 18a and 18b. These extension retraction connections, or retractable tube sections, permit the frame tubes to be selectively extended and retracted. Both of the top frame tubes 18a and 18b are divided into either two longitudinal tube sections, as best seen in FIG. 20A, or three longitudinal tube sections, shown as an alternative embodiment in FIG. 20C. In FIG. 20A, the top frame tubes each have an upper longitudinal tube section 128, which is attached to the handle portion 24 of the stroller, and a lower longitudinal tube section 126. The upper longitudinal tube section 128 has an interior cylindrical chamber with an opening 124 at its lower end facing the lower tube section 126. The lower portion of the upper longitudinal tube section, and hence the opening 124, is located forward of the pivoting connection 36 of the top frame tubes 18a and 18b. The lower tube section 126 is configured to slidably fit within the interior cylindrical chamber of the upper longitudinal tube section 128 through the opening 124, so that the lower tube section is telescopically retractable within the upper tube section.

FIG. 20C shows the alternative embodiment to FIG. 20A wherein the top frame tubes are each divided into three longitudinal sections. In FIG. 20C the top frame tubes each have an upper longitudinal tube section 110, which is attached to the handle portion 24 of the stroller, a middle longitudinal tube section 108, and a lower longitudinal tube section 106. The upper tube section 110 has an interior cylindrical chamber with an opening 104 at its lower end facing the middle tube section 108. The lower portion of the upper tube section 110, and hence the opening 104, is located forward of the pivoting connection 36 of the top frame member 18. The middle tube section 108 is configured to slidably fit within the interior cylindrical chamber of the upper section 110 through the opening 104, so that the middle tube section is retractable within the upper tube section. The middle tube section 108 also has an interior cylindrical chamber with an opening 102 at its lower end facing the lower tube section 106. The lower tube section is configured to slidably fit within the interior cylindrical chamber of the middle tube section 108 through the opening 102, so that the lower tube section is retractable within the middle tube section.

The bottom frame tubes 22a and 22b also have extension retraction connections, or retractable tube sections. As best shown in FIG. 20A, each of the bottom frame tubes comprises a forwardly located, first longitudinal tube section 114 and a rearwardly located, second longitudinal tube section 116. The first tube section has an interior cylindrical chamber with an opening 112 at its rearward end facing the second tube section 116. The second tube section 116 is configured to slidably fit within the interior cylindrical chamber of the first tube section 114 through the opening 112, so that the second tube section is retractable within the first tube section.

In some alternatives of the embodiments illustrated in FIGS. 18A-25, the upright frame tubes 20a and 20b may also have extension retraction connections, or retractable tube sections. FIG. 20B illustrates an upright frame member 20 with an upper longitudinal tube section 122 and a lower longitudinal tube section 120. The upper longitudinal tube section has an interior cylindrical chamber with an opening 118 at the lower end of the upper section 122. The lower section is configured to slidably fit within the upper section 122 through the opening 118. The upright frame tubes may also comprise more than two tube sections, with two or more retractable sections.

All of the tube sections are preferably configured such that the tube sections do not completely disengage from one another in normal operation and collapsing of the stroller for storage. In addition, all extension-retraction connections or retractable tube sections are configured such that a substantial portion of each retractable tube section can be retracted into the corresponding interior cylindrical chamber of the adjacent longitudinal tube section when the stroller is in the collapsed position.

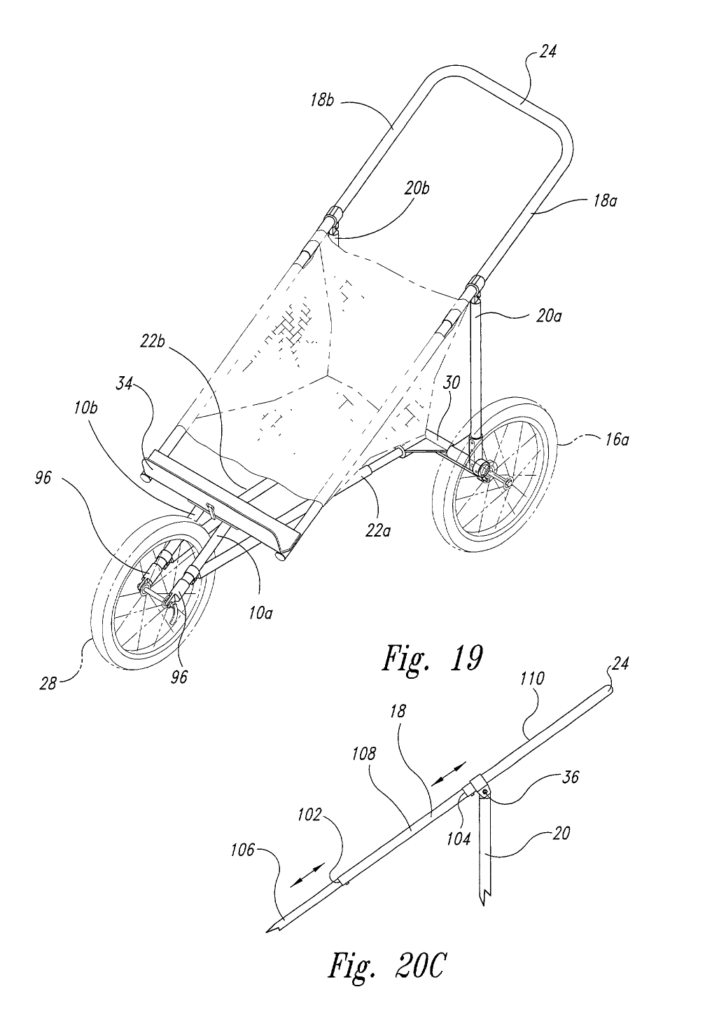

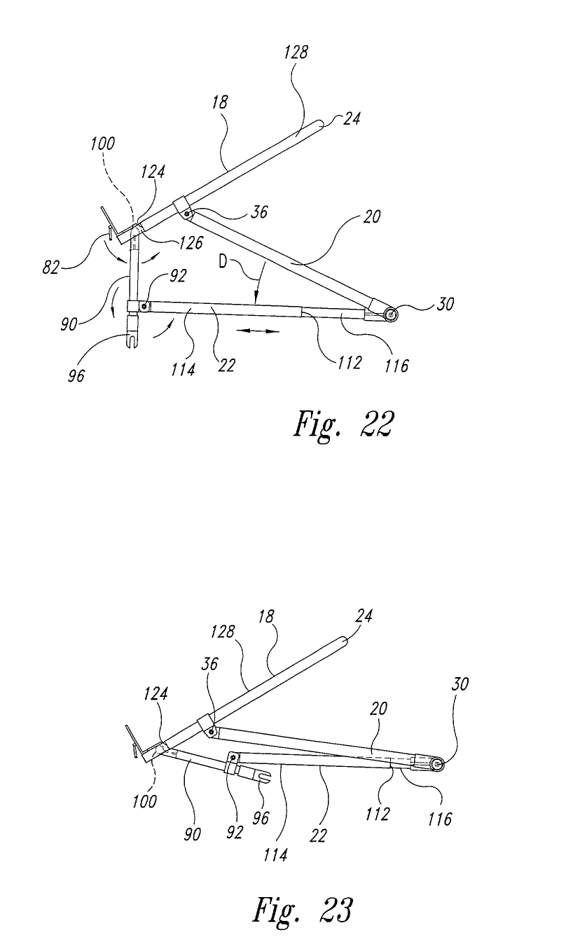

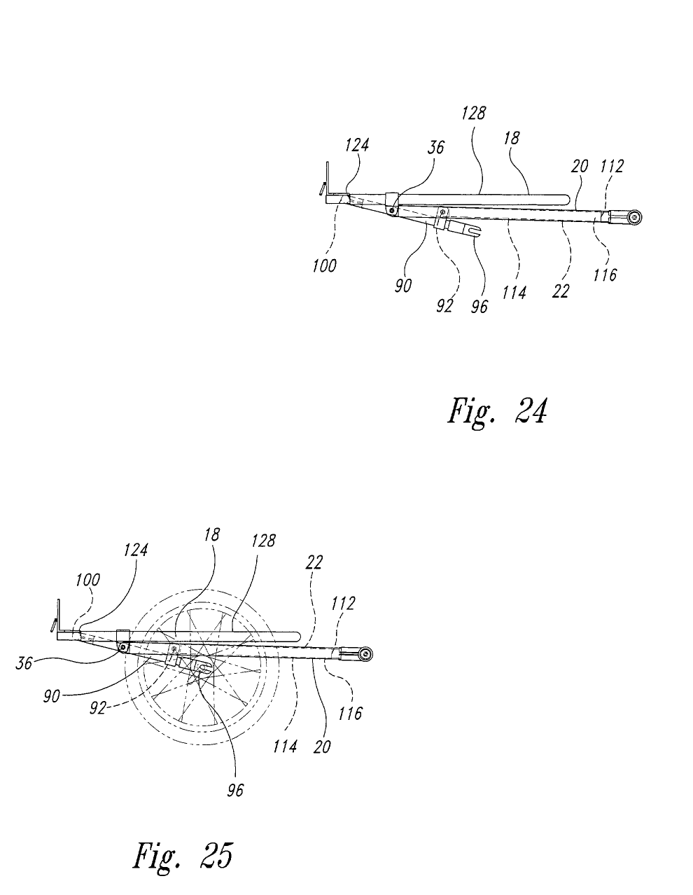

When the stroller 10 is being collapsed from the operating position shown in FIG. 20A to the collapsed position shown in FIG. 24, the user may fold the stroller through a variety of different sequences. However, FIGS. 20A through 24 show one sequence for the embodiment illustrated in FIGS. 18A and 19. The folding sequence begins in FIG. 21 by releasing the operable latch 82 so that the catch bar 80 is no longer engaged by the latch and the extended pivot links 90 are free to pivot about the pivot joints 92 and the rotatable sleeves 100 in relation to the top frame member 18 and the bottom frame member 22. As shown in FIGS. 21 through 23, the rearward end portions of the extended pivot links 90 can be folded forward rotated and counterclockwise when viewed from the left side of the stroller, as shown in the drawings, so that the pivot joints 92 are rearward of the rotatable sleeves 100. As can be seen in FIGS. 21 and 22, the lower tube sections 126 of the top frame tubes 18a and 18b can be retracted into the interior cylindrical chambers of the upper tube sections 128 such that the rotatable sleeves 100 are proximate the openings 124 of the upper tube sections 128. Furthermore, as seen in FIGS. 21 and 23, it can be seen that the second sections 116 of the bottom frame tubes 22a and 22b can be retracted into the first tube sections 114 so that the openings 112 of the interior cylindrical chambers of the first tube sections 114 are proximate the pivoting couplers 30.

FIGS. 21 through 23 show that as the rearward end portions of the extended pivot links 90 are folded forward, the upright frame member 20 pivots in relation to the bottom frame member 22, and the top frame member 18, about the pivoting connections 36 and the pivoting couplers 30, so that the upper end portions of the upright frame tubes 20a and 20b fold forward and downward toward the bottom frame member 22, in the direction of arrow “D” on FIG. 22.

Lastly, as shown in FIGS. 23 and 24, the stroller can be further collapsed to place the upright frame member 20, the top frame member 18, and the bottom frame member 22 in substantial parallel relation to one another. The stroller is configured so that the user is able to collapse the stroller without removing the front wheel 28 from the fork tips 96 as shown in FIG. 25, or to remove the front wheel if desired, to achieve the configuration shown in FIG. 24. When the front wheel 28 is not removed, it projects between the left and right tubes of the bottom frame member 20, and also of the upright frame member 20 and the top frame member 18.

The lower and upper tube sections 126 and 128 of the top frame tubes 18a and 18b, and the first and second tube sections 114 and 116 of the bottom frame tubes 22a and 22b are releasably lockable relative to the longitudinally adjacent tube section to permit their selective locking in the extended position and release for movement into the retracted position. The tube sections may also be locked in the retracted position. This is accomplished by a locking means located near each of the openings 112 and 124 of each of the tube sections 114, 116, 126 and 128. In the embodiment shown in FIGS. 18A-25, the locking mechanism comprises a conventional spring loaded button attached to one tube section and receiver hole in the adjacent tube section. The extension-retraction connections of the alternate embodiments can also comprise locking means to lock the tube sections in the extended or retracted positions.

From the foregoing it will be appreciated that, although specific embodiments of the invention have been described herein for purposes of illustration, various modifications may be made without deviating from the spirit and scope of the invention. For example, the extension-retraction connections may comprise other structures, aside from telescoping structures, which permit movement of the longitudinal portions of an elongated frame member relative to one another along the longitudinal axis of the longitudinal portions, while retaining the portions in substantial parallel alignment in relation to one another throughout a movement between an extended position and a retracted position. Various alternative embodiments could also comprise various means for locking the extension-retraction connections in the extended or retracted positions.

What is claimed is:

1. A baby stroller comprising:
at least one front wheel;
at least one rear wheel;
at least one top frame member having a forward end portion and a rearward end portion;
at least one bottom frame member having a forward end portion and a rearward end portion, the at least one rear wheel being rotatably attached to the bottom frame member;
at least one upright frame member having an upper end portion and a lower end portion, the upper end portion of the upright frame member being connected to the top frame member, and the lower end portion of the upright frame member being connected to the bottom frame member; and
at least one linking member pivotally connected to the forward end portion of the top frame member and pivotally connected to the forward end portion of the bottom frame member, with the at least one front wheel being rotatably attached to the linking member.

2. A baby stroller comprising:
at least one rear wheel;
at least one front wheel;
at least one elongated top frame member having a forward end portion and a rearward end portion with at least a longitudinal portion therebetween extending along a longitudinal axis thereof;
at least one elongated bottom frame member having a forward end portion and a rearward end portion with at least a longitudinal portion therebetween extending along a longitudinal axis thereof, the at least one rear wheel being rotatably connected to the rearward end portion of the bottom frame member when the stroller is in an operating position;
at least one elongated upright frame member having an upper end portion and a lower end portion with at least a longitudinal portion therebetween extending along a longitudinal axis thereof, the upper end portion of the upright frame member being connected to the top frame member, and the lower end portion of the upright frame member being connected to the bottom frame member; and
at least one linking member having a forward end portion and a rearward end portion with at least a longitudinal portion therebetween extending along a longitudinal axis thereof, the linking member being pivotally connected to both the forward end portions of the bottom frame member and the top frame member, with the at least one front wheel being rotatably attached to the linking member when the stroller is in an operating position.

3. The baby stroller of claim 2 wherein the forward end portion of the linking member is pivotally connected to the forward end portion of the bottom frame member and the rearward end portion of the linking member is pivotally connected to the forward end portion of the top frame member.

4. The baby stroller of claim 2 wherein when in the operating position of the stroller, the longitudinal portion of the linking member is in substantial parallel alignment with the longitudinal portion of the top frame member, with the forward end portion of the linking member protruding forward beyond the forward end portions of the top frame member and bottom frame member and the at least one front wheel being rotatably connected to the forward end portion of the linking member.

5. The baby stroller of claim 2 wherein the upper end portion of the upright frame member is pivotally connected to the rearward end portion of the top frame member and the lower end portion of the upright frame member is pivotally connected to the rearward end portion of the bottom frame member, and the upright frame member, top frame member, and bottom frame member are pivotally movable when moved into a collapsed position of the stroller where each is in substantial parallel alignment, with the forward end portion of the linking member pivoted rearward.

6. The baby stroller of claim 2 wherein the upright frame member is pivotally connected to the top frame member and pivotally connected to the bottom frame member.

7. The baby stroller of claim 2 wherein the longitudinal portion of at least one of the top, bottom, and upright frame members comprises at least a first longitudinal section and a second longitudinal section, the longitudinal portion being configured to permit the first and second sections to move relative to one another along the longitudinal axis of the longitudinal portion, while retaining substantial alignment in relation to one another throughout the movement, between an extended position and a retracted position, with the length of the longitudinal portion being greater in the extended position than in the retracted position.

8. The baby stroller of claim 7 wherein the stroller is configured to collapse from the operating position to a collapsed position, the operating position comprising the longitudinal portion of the linking member being in substantial alignment with the longitudinal portion of the top frame member with the forward end portion of the linking member protruding forward beyond the forward end portion of the top frame member and having the at least one front wheel attached to the forward end portion of the linking member, and the collapsed position comprising each of the longitudinal portions of the upright frame member, bottom frame member, and top frame member being in near parallel alignment, and the forward end portion of the linking member being pivoted to a position rearward of the forward end of the top frame member.

9. The baby stroller of claim 8 wherein the collapsed position further comprises the first and second sections being in the retracted position.

10. The baby stroller of claim 8 wherein the front wheel is removable and is removed when the stroller is in the collapsed position.

11. The baby stroller of claim 4 wherein the upright frame member is pivotally connected to both the top frame member and bottom frame member, and the at least one front wheel is removable, and the stroller is configured such that the top frame member, bottom frame member, upright frame member and linking member can be pivoted from the operating position to a collapsed position, the collapsed position comprising each of the longitudinal portions of the upright frame member, bottom frame member, and top frame member being in near parallel alignment, with the linking member being pivoted away from the operating position such that the forward end portion of linking member is positioned rearward of the forward end portion of the top frame member.

12. The baby stroller of claim 11 wherein the at least one front wheel is removed when the stroller is in the collapsed position.

13. A baby stroller comprising:
a left rear wheel and a right rear wheel;
at least one front wheel;
a bottom frame member having a bottom left side frame tube and a bottom right side frame tube, each of the bottom frame tubes having a forward end portion and a rearward end portion and a longitudinal axis extending therebetween, the bottom frame tubes being in substantial parallel alignment and spaced apart relationship to one another, the left rear wheel, and the right rear wheel being rotatably mounted to the bottom frame member;
a top frame member having a top left side frame tube and a top right side frame tube, each of the top frame tubes having a forward end portion and a rearward end portion and a longitudinal axis extending therebetween, and being in substantial parallel and spaced apart relationship to one another;
an upright frame member having an upright left side frame tube and an upright right side frame tube, each of the upright frame tubes having a upper end portion and a lower end portion and a longitudinal axis extending therebetween, the upright frame tubes being in substantial parallel alignment and spaced apart relationship to one another, with the upper end portions of the upright frame tubes being pivotally connected to the rearward end portions of the top frame tubes, and the lower end portions of the upright frame tubes being pivotally connected to the rearward end portions of the bottom frame tubes; and
a left side extended pivot link and a right side extended pivot link, each extended pivot link having a forward end portion and a rearward end portion and a longitudinal axis extending therebetween, the rearward end portions of the left side and right side extended pivot links being pivotally connected to the corresponding forward end portions of the left side and right side top frame tubes, and the forward end portions of the left side and right side extended pivot links being pivotally connected to the corresponding forward end portions of the left side and right side bottom frame tubes, with the forward end portions of the extended pivot links protruding forward past the forward ends of the top frame tubes and bottom frame tubes with the at least one front wheel being rotatably mounted between and to the forward end portions of the extended pivot links when the stroller is in an operating position.

14. The baby stroller of claim 13 wherein the left and right side frame tubes of at least one member of the bottom, top and upright frame members are each divided into at least a first longitudinal tube section and second longitudinal tube section, the first longitudinal tube section having an interior cylindrical chamber with an opening at an end thereof facing the second longitudinal tube section, the second longitudinal tube section being configured to slidably fit within the interior cylindrical chamber of the first longitudinal tube section through the opening, the second longitudinal tube section being axially movable within the first longitudinal tube section such that the left and right side frame tube can be positioned in an extended position or a retracted position with a length of the frame tubes being greater in the extended position than in the retracted position.

15. The baby stroller of claim 14 wherein the operating position of the stroller further comprises the top frame tubes being disposed in a downwardly forward sloping configuration with the upright frame tubes disposed near vertically, and the bottom frame tubes disposed near horizontally, with the extended pivot links being positioned in near alignment with the top frame tubes and extending forward past the forward end portions of the top frame tubes.

16. The baby stroller of claim 14 wherein the wherein the stroller is configured to fold from the operating position, to a collapsed position wherein each of the top frame tubes, bottom fame tubes, and upright frame tubes are substantially parallel, and the extended pivot links are pivoted such that the forward end portions of the extended pivot links are positioned rearward of the forward end portions of the top frame tubes, and wherein collapsed position further comprises each of the divided frame tubes being in the retracted position.

17. The baby stroller of claim 13 further comprising a manually operable latch and catch member, the catch member extending between the extended pivot links and being fixedly attached to the extended pivot links, and the latch being connected to the top frame tubes and configured to selectively engage and hold the catch member in a static position such that the extended pivot links are secured in the operating position.

18 The baby stroller of claim 13 wherein the stroller is configured to fold from the operating position, to a collapsed position wherein each of the top frame tubes, bottom fame tubes, and upright frame tubes are substantially parallel, and the extended pivot links are pivoted such that the forward end portions of the extended pivot links are positioned rearward of the forward end portions of the top frame tubes.

19. A foldable baby stroller frame for use with at least one front wheel and at least one rear wheel, comprising:
a top frame having a forward end portion and a rearward end portion;
a bottom frame having a forward end portion and a rearward end portion, the at least one rear wheel being rotatably attachable to the bottom frame; and
a linking member pivotally connected to the forward end portion of the top frame and pivotally connected to the forward end portion of the bottom frame, with the at least one front wheel being rotatably attachable to the linking member.

20. The baby stroller frame of claim 19 further including an upright frame having an upper end portion and a lower end portion, the upper end portion of the upright frame being connected to the top frame, and the lower end portion of the upright frame being connected to the bottom frame.

21. The baby stroller frame of claim 20 wherein the upper end portion of the upright frame is pivotally connected to the rearward end portion of the top frame, and the lower end portion of the upright frame is pivotally connected to the rearward end portion of the bottom frame.

22. The baby stroller frame of claim 19 wherein the linking member has a forward end portion pivotally connected to the forward end portion of the bottom frame and a rearward end portion pivotally connected to the forward end portion of the top frame.

23. The baby stroller frame of claim 22 wherein the linking member is pivotable relative to the bottom and top frames between an operating position with the forward end portion of the linking member forward of the rearward end portion thereof and a collapsed position with the forward end portion of the linking member rearward of the rearward end portion thereof.

24. The baby stroller frame of claim 22 wherein the linking member is pivotable relative to the bottom and top frames between an operating position and a collapsed position, and wherein the at least one front wheel is rotatably attachable to the forward end portion of the linking member at a location to position the at least one front wheel forward of the pivotal connection of the forward end portion of the linking member to the forward end portion of the bottom frame when the stroller is in the operation position and rearward of the pivotal connection of the forward end portion of the linking member to the forward end portion of the bottom frame when the stroller is in the collapsed position.

25. The baby stroller frame of claim 22 wherein the linking member is pivotable relative to the bottom and top frames between an operating position with the forward end portion of the linking member extending forward and a collapsed position with the forward end portion of the linking member extending rearward.

26. The baby stroller frame of claim 22 wherein the at least one front wheel is rotatably attachable to forward end portion of the linking member at a location forward of the pivotal connection of the forward end portion of the linking member to the forward end portion of the bottom frame.

27. The baby stroller frame of claim 22 wherein the at least one front wheel is rotatably attachable to the forward end portion of the linking member at a location forward of the pivotal connection of the rearward end portion of the linking member to the forward end portion of the upper frame.

28. The baby stroller frame of claim 19 wherein the linking member has a forward end portion and a rearward end portion with the forward end portion thereof being forward of the rearward end portion thereof when the stroller is in an operating position, the at least one front wheel being rotatably attachable to the forward end portion of the linking member.

29. The baby stroller frame of claim 19 wherein the linking member has a first end portion pivotally connected to the forward end portion of the bottom frame and a second end portion pivotally connected to the forward end portion of the top frame, the linking member being pivotable relative to the bottom and top frames between an operating position and a collapsed position, and wherein the at least one front wheel is rotatably attachable to the first end portion of the linking member at a location to position the at least one front wheel in a first position for operation when the stroller is in the operation position and in a second position rearward of the first position when the stroller is in the collapsed position.

30. The baby stroller frame of claim 19 wherein the linking member has a first end portion pivotally connected to the forward end portion of the bottom frame and a second end portion pivotally connected to the forward end portion of the top frame, the bottom and top frames being pivotable relative to the linking member to permit movement of the bottom and top frames between an operating position and a collapsed position, and wherein the at least one front wheel is rotatably attachable to the first end portion of the linking member at a location to position the at least one front wheel in a first front wheel position for operation when the stroller is in the operation position and in a second front wheel position spaced apart from the first front wheel position when the stroller is in the collapsed position.

31. The baby stroller frame of claim 30 wherein the bottom and top frames are pivotable relative to the linking member to permit movement of the bottom and top frames away from each other into a first frame position with the top frame spaced apart from the bottom frame for operation when the stroller is in the operation position and toward each other into a second frame position with the top frame adjacent to the bottom frame when the stroller is in the collapsed position.

32. The baby stroller frame of claim 31 wherein the second front wheel position is rearward of the first front wheel position.

33. The baby stroller frame of claim 30 wherein the top frame includes at least one elongated top frame member having a forward end portion and a rearward end portion with a longitudinal portion therebetween extending along a longitudinal axis thereof, and the bottom frame includes at least one elongated bottom frame member having a forward end portion and a rearward end portion with a longitudinal portion therebetween extending along a longitudinal axis thereof.

34. The baby stroller frame of claim 33 wherein the longitudinal portion of at least one of the top and bottom frame members comprises at least a first longitudinal section and a second longitudinal section, the longitudinal portion being configured to permit the first and second sections to move relative to one another along the longitudinal axis of the longitudinal portion, while retaining substantial alignment in relation to one another throughout the movement, between an extended position and a retracted position, with the length of the longitudinal portion being greater in the extended position than in the retracted position.

35. The baby stroller frame of claim 34 wherein when the stroller is in the collapsed position the first and second sections are in the retracted position.

36. The baby stroller frame of claim 34 wherein the first and second sections are telescopically disposed with the first section within and extendible from the second section.

37. The baby stroller frame of claim 33 further including at least one elongated upright frame member with an upper end portion and a lower end portion, the upper end portion of the upright frame member being pivotally connected to the rearward end portion of the top frame, and the lower end portion of the upright frame member being pivotally connected to the rearward end portion of the bottom frame, the upper end and lower end portions of the upright frame member having a longitudinal portion therebetween extending along a longitudinal axis thereof, the longitudinal portion of at least one of the top, bottom and upright frame members comprises at least a first longitudinal section and a second longitudinal section, the longitudinal portion being configured to permit the first and second sections to move relative to one another along the longitudinal axis of the longitudinal portion, while retaining substantial alignment in relation to one another throughout the movement, between an extended position and a retracted position, with the length of the longitudinal portion being greater in the extended position than in the retracted position.

38. The baby stroller frame of claim 37 wherein when the stroller is in the collapsed position the first and second sections are in the retracted position.

39. The baby stroller frame of claim 37 wherein the first and second sections are telescopically disposed with the first section within and extendible from the second section.

40. A baby stroller frame for use with at least one front wheel, comprising:
a top frame and a bottom frame, each having a forward end portion and a rearward end portion;
a linking member, pivotally connected to a forward end portion of at least one of the top frame and bottom frame, and having a wheel mounting portion to which the at least one front wheel can be rotatably attached, the linking member being pivotable between an operating position and a collapsed position.

41. The baby stroller frame of claim 40 wherein the pivoting connection of the linking member is configured to allow the linking member to pivot such that the position of the wheel mounting portion of the member can be changed.

42. The baby stroller frame of claim 40 wherein a distance between the wheel mounting portion and one of the top and bottom frame is greater when the linking member is in the operating position than in the collapsed position.

43. The baby stroller frame of claim 40 wherein the linking member has a forward end portion and a rearward end portion, the forward end portion being forward of the rearward end portion when the linking member is placed in the operating position and a distance between the forward end of the linking member and a rearward end of one of the top and bottom frame is greater in the operating position than in the collapsed position.

44. The baby stroller frame of claim 40 wherein when the frame is in the operating position the linking member extends forward and downward from the forward end of the top frame and is in substantial alignment with the top frame.
